(19) United States
(12) Patent Application Publication
(10) Pub. No.: US 2010/0306989 A1
(43) Pub. Date: Dec. 9, 2010

(54) PALLET ASSEMBLY PROCESS

(75) Inventors: Daniel Tingley, Corvallis, OR (US); Keith Dunlap, Corvallis, OR (US); Paul Richmond, Corvallis, OR (US)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: Miller Dowel Company, Northfield, IL (US)

(21) Appl. No.: 12/699,444

(22) Filed: Feb. 3, 2010

Related U.S. Application Data
(60) Provisional application No. 61/149,817, filed on Feb. 4, 2009.

(51) Int. Cl. B23P 25/00

(52) U.S. Cl. 29/458

(57) ABSTRACT

A method of manufacturing a wooden pallet secured by glue and dowels is disclosed. The method comprises preparing and arranging the pallet components; drilling dowel holes in the pallet components; applying glue to the dowels and the pallet components; assembling the pallet components to form assembled components; securing the assembled components together with dowels and glue; and clamping the assembled components for a period of time sufficient to allow the glue to cure and form an assembled wooden pallet.

### RELATED APPLICATION

This application is related to U.S. provisional application 61/149,817, filed Feb. 4, 2009, entitled “PALLET ASSEMBLY PROCESS” which is incorporated by reference herein in its entirety.

### FIELD OF THE INVENTION

This application relates to pallets, and more particularly to a method for assembling pallets.

### BACKGROUND OF THE INVENTION

Pallets are used for shipping and warehousing of materials. Glued pallets have a reduced weight due to reduced material component size and number as well as the elimination of typical methods of assembling pallets with metal fasteners, such as nails. Such reduction in the size and weight of pallet components is achieved by the creation of superior joints that are manufactured with glue versus the conventional methods utilizing metal fasteners. The superior joints allow better translation of applied stresses between components, as well as allow superior strength and stiffness. Such a pallet can have components that are thinner, smaller in surface area and lower in strength and quality. The all glued pallets have superior vibrational damping resistance as the joints are all considered fixed versus pinned, as in a metallic fastener connected pallet.

One type of a glued wood pallet is a block pallet. The deck stringers on a block pallet can be manufactured to maximize strength and to save the most weight. The boards used in the manufacture of the pallet can be oriented so that the grain orientation has the crowns up, which means that the annual rings form a curve with the top of the curve toward the top of the pallet face. Wood oriented in this direction is stronger when the load is applied towards the top of the crown in the wood. On block pallets the bottom boards can be selected to increase the surface area of the bottom bearing points in the pallet by distributing the load of the pallet on surfaces it is stacked on. This allows more stable free stacking of larger loads. If the pallet does not need to be self stacked and higher bearing stresses can be accommodated, then reduced bottom stringers and bottom lead board areas can be utilized to reduce weight and save money. Similarly the top surface area of the pallet can be modified to accommodate the requirements of the intended use.

One benefit of the present invention is that repairs for individual broken or damaged components can be made relatively easily in-situ. These repairs are a lot easier, quicker and more economical because the individual components are glued in place and thus held together with a complete component to component bond versus a pallet where metal fasteners have been utilized. In a metal fastener type pallet the components will fall off the pallet when the failure separates the piece from any one metal fastener.

### SUMMARY OF THE INVENTION

The invention comprises assembling a pallet with glued joints in a process having a plurality of steps involving positioning the components, doweling, gluing, assembling and clamping the pallet.

### CONCISE DESCRIPTION OF THE DRAWINGS

FIG. 1 is a perspective view of the ladder assembly in a jig.

FIG. 2 is a perspective view of the assembly of the assembly bottom in a jig.

FIG. 3 is a view of the bottom assembly.

FIG. 4 is a view of the ladder assembly in a clamp.

FIG. 5 is a view of the clamped final assembly

### DETAILED DESCRIPTION OF THE INVENTION

The subject invention is a process for assembling a block pallet (shown in FIG. 8) by first preparing a ladder assembly and a bottom assembly, and then securing the two assemblies together to form the block pallet.

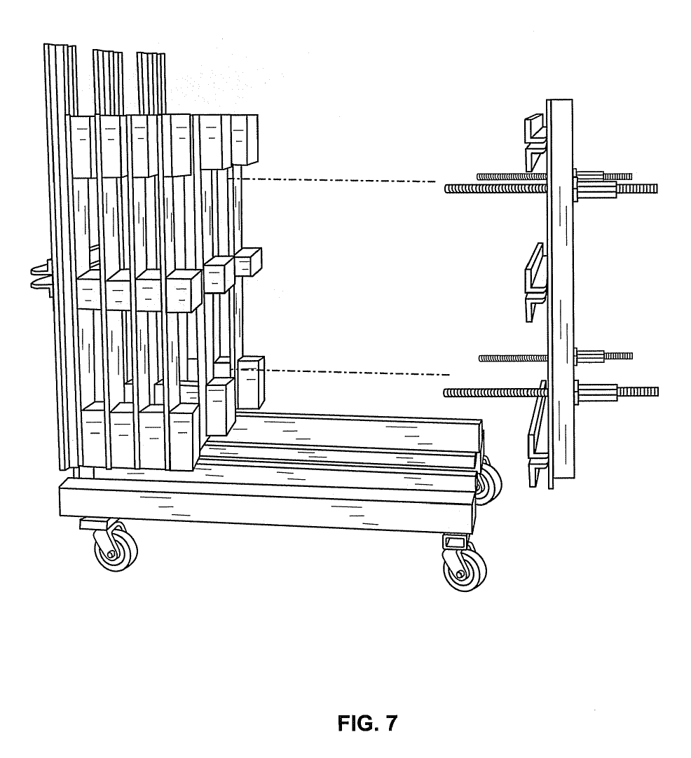

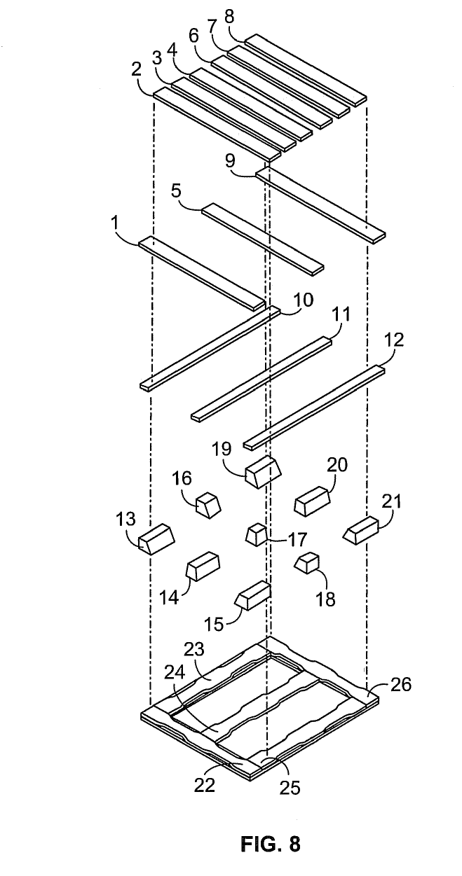

The ladder clamp (FIGS. 4 and 5) is used to clamp the assembly called the ladder assembly. The ladder assembly is made of three top stringers and deck boards. The ladder assembly includes top stringers and certain deck boards. The ladder assembly can have other configurations and numbers of deck boards. Subsequently the ladder assembly can be modified to accommodate other configurations where component size, number, configuration, location, type, orientation of grain, and grade vary.

The bottom clamp (FIG. 7) is used to manufacture the subunit called the bottom assembly. The bottom assembly includes three bottom stringers and two bottom lead boards and nine blocks. One type of block pallet can involve as many as four (4) different types of blocks and each is used in specific locations. This creates a wide range of required pressures for proper gluing. The vertical clamping bars are long bars. The horizontal clamping bar is a short bar and is located by pegs fixed in the two outside long clamping bars. Four screws go through this bar where the center deck board will go later in a later stage of the full pallet assembly. Subsequently the bottom assembly can be modified to accommodate other configurations where component size, number, configuration, location, type, orientation of grain, and grade vary.

The final clamp (FIG. 6) is used to manufacture the final assembled pallet. It brings together the bottom assembly and the ladder assembly with individual components as required. The final clamp may include a ladder and a bottom assembly and two top lead boards and the center deck board. The vertical clamping bars are long bars whose length is determined by the size of the pallet to be assembled. The horizontal clamping bar is a short bar (length determined by the size of the pallet to be assembled) and is located by pegs fixed in the two outside long clamping bars. Four screws go through this bar between the middle deck boards 5. This bar is above the center of the pallet. The pegs for locating the horizontal clamping bar are the only difference between the bottom assembly clamp and the final assembly clamp. Subsequently the bottom assembly can be modified to accommodate other configurations where component size, number, configuration, location, type, orientation of grain, and grade are different.

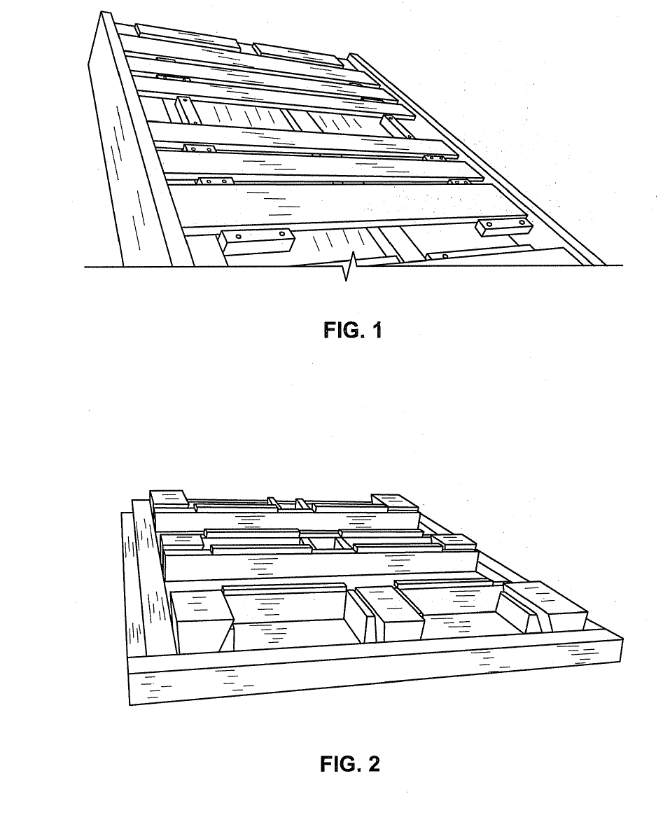

As stated above, the pallet to be assembled can be divided into two separate components for separate assembly: the top ladder portion and the bottom portion. In general, pallets are prepared of pine, specifically southern pine, and the glue used is phenolic glue. A typical block pallet is shown (exploded) in FIG. 8. In preparing the ladder portion one positions a jig in the work area. The jig is vacuumed and inspected for loose parts, fixing required. The stringers 10-12 are placed in an appropriate position in the jig (FIG. 1) while the deck 3-7 and lead boards 1, 2, 8 and 9 are put in the appropriate position in the jig. The drill template is placed in jig, making sure orientation is correct. With a center pointed wood bit, one drills through hole locations in the drill template, approximately 1/16″ into pallet material. The template is removed, and using a step drill with the collar placed, while holding the drill perpendicular to the pallet surface, and the bit in the center dimple, dowel holes are drilled, stopping when the collar touches the wood. The pallet components are carefully removed from the jig. Any burrs or splintering are removed. The ladder portion is then placed in a storage area with each element aligned as they were in the jig. It is important to maintain these positions as each part is unique to orientation and position.

The lead boards 22 and 26 are removed from the storage rack and placed in the work area in a proper orientation and position so that when the subsequent gluing operation is performed they are positioned correctly. The adjacent deck boards 3-7 are removed from storage area and placed on top of the lead board 22 and 26 in the work area. The stringers 10-12 are removed from the storage area and placed on the workstation side by side maintaining the proper orientation. Using guides on the workstation surface, glue is placed only where the boards will cross. Stringers are moved to the appropriate locations on the workstation.

The three board stack is then placed on top of the glued area for the lead board. The two deck boards are placed on the glue area for the adjacent deck board. The last deck board is placed on the remaining glue area on the stringer. A dowel is brushed with glue and placed in holes in the ladder portion. Using a hammer the dowels are driven 1/16″ below the board surface. Alternately, some other countersinking device may be used. With a wet cloth all excess glue is wiped off. The ladder 15 placed in the ladder clamp separated with a parting film (FIG. 4). Place clamp platen, screws, washers, and nuts to secure the ladder assembly in place (FIG. 5).

An impact wrench is used to run up the nuts to the platen. Using a torque wrench, screws are tightened to the specified torque which will create a target pressure at specific locations of about 125 psi to 400 psi and preferably 300 psi for each screw. Place in curing area for about 4 hours at 80° F. and up to 12 hours at ambient (70° F.) to allow the assembly to partially cure. Remove the clamped system from the curing area, open the clamp and remove the pallet.

In preparing the bottom portion, one places the jig in the work area checking orientation. The jig is vacuumed and inspected for loose parts and fixed as required. The blocks 13-21 (FIG. 8) are placed in the appropriate position in the jig, ensuring that every block type is in its proper pocket in the jig. The drill template is placed in the jig making sure the orientation is correct. With a center pointed wood bit, one drills through hole locations approximately 1-16″ into pallet material. The template is then removed. Using a step drill bit with collar placed, while holding the drill perpendicular to pallet surface, and the bit in the centering dimple, dowel holes are drilled, stopping when the collar touches the wood. Pallet pieces are carefully removed from the jig and burrs or splintering are removed. The pallets with dowel holes are then placed in a storage area with each element aligned as they were in the jig. It is important to maintain these positions as each part is unique to its position and orientation.

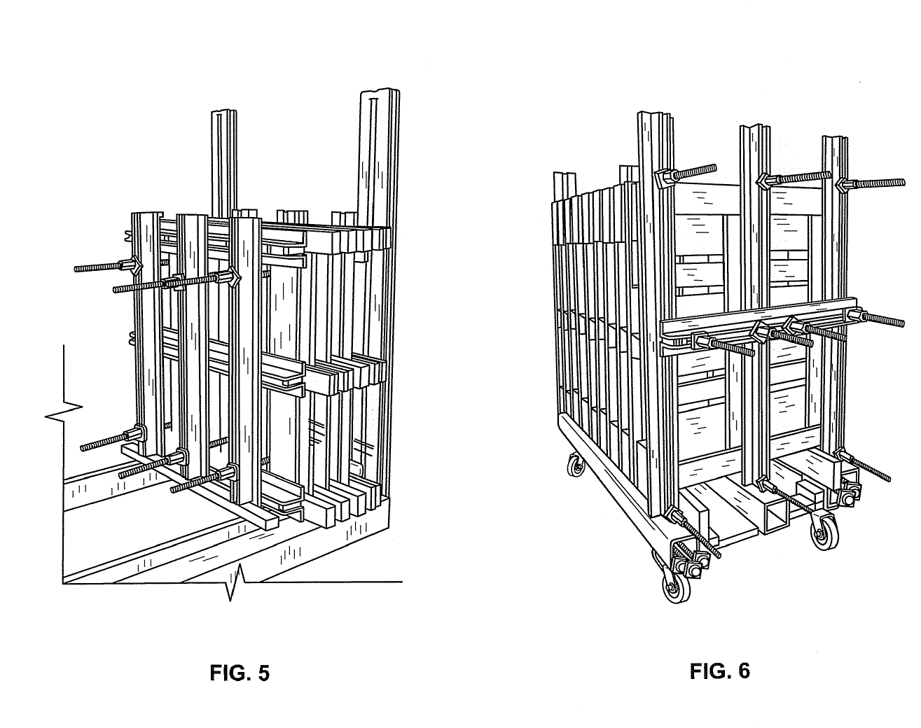

The glue may be prepared while the following is being attended to. All of the blocks are removed from storage area maintaining their orientation and relative position and placed in the work area. Bottom lead boards 22 and 26 are removed from the storage area and placed on top of the corner block in the work area. The three bottom stringers 23-25 are removed from storage insuring proper orientation and placed on top of the blocks (FIG. 3). The appropriate dowel is taken from storage and brushed with glue. The dowel with glue is placed in holes in the bottom assembly using a hammer; dowels are driven to seat properly in the pilot hole.

Invert the hammer and using the ball peen, drive the dowels 1/16″ below board surface. A countersinking device may be used in the alternative. Remove the bottom assembly and place in the bottom clamp, separated with parting film. Place clamp bars, screws, washers and nuts to secure the bottom assembly in place. Use an impact wrench to run up the nuts to the clamp bar. Using a torque wrench tighten the screws to the specific torque that results in an applied pressure in the glueline of about 125 psi to 400 psi, preferably 300 psi for each screw. Place the secured clamped assembly in the curing area. Allow sufficient time to cure (at least 4 hours at 80° Fand up to 12 hours at room temperature, e.g., 72° F.). Remove the clamped system from curing area and open the clamp.

The glued bottom assembly is then removed from the storage area and placed in the final assembly jig. The glued ladder assembly is removed from the storage area and placed in a final assembly jig. The drill template is placed on the jig, making sure orientation is correct, approximately 1/16″ into the pallet. With a center pointed wood bit, hole locations are drilled approximately 1/16″ into the pallet material. The template is removed.

Using a step drill with collar placed, while holding the drill perpendicular to pallet surface, bit in centering dimple, dowel holes are drilled, stopping when the collar touches the wood. A bottom subassembly is removed from the storage area and placed in the final assembly area. A ladder subassembly is removed from the storage stack and is placed on top of the bottom assembly, maintaining a proper orientation. The outside lead boards are removed from the storage area and placed on top of the ladder assembly maintaining proper orientation. The center deck board is removed from the storage stack and placed on top of the ladder subassembly, maintaining proper orientation. A dowel is placed with glue into the drilled dowel holes in the assembly. Using a hammer the dowels are driven home.

The hammer is inverted and using the ball peen the dowels are driven 1/16″ below the board surface. The assemblies are then removed and placed in the ladder clamp separated with parting film. Clamp platen, screws, washers, and nuts are placed in position using an impact wrench the nuts are run up to the plate. Using a torque wrench the screws are tightened to the specific torque of about 125 psi to 400 psi and preferably 300 psi for each screw. The clamped assembly is then placed in the curing area (FIGS. 5 and 6). Allow the clamped assembly to partially cure for at least 4 hours at 80° F. or over and up to 12 more hours at ambient temperature 70° F. Alternative methods of curing the glue may be utilized, such as microwave and radio frequency.

The glue discussed may be applied in many ways from brushing to the use of a spray and roller coating method. It may be applied partially polymerized such as in an A-Staged phenolic type glue or conversely the glue can be cured by heat or by a water mist. There are many ways to apply and cure and utilize the adhesive used in the assembly of all glued pallets, and the above list is not intended to be all encompassing.

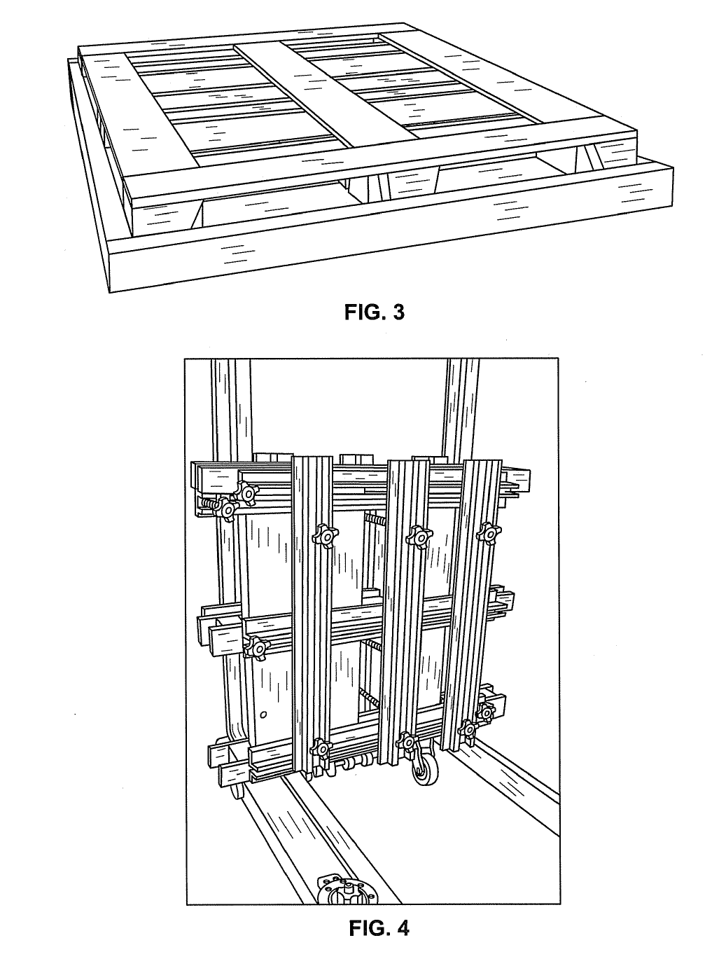

The pallet clamping device can be a mobile clamping system. This system is made up of three (3) clamp types called the; ladder clamp (FIG. 4), Bottom Clamp (FIG. 7) and Final Clamp (FIG. 6). This system is an open face clamp system that has a base with a backplane that can be mounted on castors (FIG. 6). This system creates a uniform pressure between a backplane and front platen or clamping bars (FIGS. 2 and 3). The clamping system castors allow the clamps to be easily moved to assembly areas to be loaded with pallet final assembly or subassembly materials. Alternatively, the clamping system can be fixed to the floor instead of having castors attached. Further, the clamping system may be vertical instead of horizontal such that it can be placed in line with manufacturing or in another convenient location with regard to the pallet assembly.

Once the clamps are loaded they can easily be moved to a heated temperature curing area if required by the glue type. Once cured, the clamps are then moved to a finishing area and emptied. The casters facilitate moving and storage. The platen or clamping bars are positioned to directly compress specific joints. Clamping screws can be made from all-thread-rod and welded nuts, then nuts and washers (e.g. square washers ¼″ thick) on both sides of the clamp. These screws are tightened to apply a known pressure to specific joints. Alternatively the screws can be replaced by any force system that produces a force at a specified point where a screw is currently shown, for example, hydraulic pistons.

Specific pressures on the gluelines are achieved by torque being applied to the nuts on the individual screws, as required, to achieve the pressures needed for proper gluing. This torque magnitude is calculated based on the required pressure and area to be glued under the load point. It is essential that the backplane is flat and perpendicular to the screws to equalize the forces across the pallet surface. The platen and clamp bars must be parallel to the backplane when the required torque levels on each of the screws are reached. During the calibration process the deformation of the platen may be checked with extensometers to insure the platen is flat to within 002″. Further, the size of the area to be glued at any one clamp pressure point might vary within a clamp point. This occurs since more than one glue line in one pallet or pallet subassembly or within multiple pallets or subassemblies are being clamped. The clamp points may, or may not contain dowels with end grain exposed to the clamp pressure and will contain wood with tangential grain and radial grain exposed with different compression Modulus of Elasticity values which leads to a different deformation of the wood for each lamination under pressure at the clamp point. The clamp should allow the application of specific pressures as required at each of the areas to be glued in the pallet. This allows the pressure to be specific to the situation allowing the proper average pressure in each strata glue line.

One of the preferred benefits of this invention is the ability to create different pressures at different locations in the pallet during the gluing process.

Another preferred benefit is the ability to monitor the pressure applied.

Another preferred benefit is the ability to move the clamps around from the assembly table to the heated area (if required by the glue) or storage area while the glue cures.

Another preferred benefit is the ability to retorque the pressure points in the Block Pallet Clamp as the glue in the glue line migrates to the outside edges of the glue line thereby reducing the pressure due to hydrostatic pressure release in the glue line. This allows the proper clamp pressure to be maintained during the glue line curing. Since there are independent pressure clamp points this retorquing can be different based on the different spread rates of the glue in the glue line that may have been applied during the glue application process. Other differences such as glue line area, wood type, wood grade, wood dryness, and wood grain orientation may lead to different re-torquing requirements.

Another preferred benefit of this invention is the ability to place the glued assemblies or final assemblies in the clamp and create enough pressure to the glued subassemblies or final assemblies in a single or various multiple subassembly or final assembly arrangements to cause the glued surfaces to come together without significant pressure on them so that they are just touching. This allows the glue to penetrate the surface of the wood on each side of the glue line which creates better glue line shear strength. This can occur while the glue is being applied to the glue lines in assemblies not yet completed and placed in the clamps as well as when subassemblies and final assemblies are being positioned in the block pallet clamps.

Another preferred benefit of this invention is the ability to partially or slowly torque the subassemblies and final assemblies during an extended close period specified for use with some adhesives like resorcinol. This allows better migration of the glue into the adjacent wood surfaces on each side of the glue line during the early stages of glue pre-polymerization.

Another preferred benefit of this invention is the low cost of manufacturing multiple block pallet clamps which is very low for these types of clamps compared to other conventional platen presses. Due to this low cost of manufacture many clamps can be manufactured for a relatively low cost per clamp so that assembly and clamping of glued Block Pallets can occur within the open time of the glue, e.g. 1 hour, for resorcinol. Whatever number of subassembly or final assembly units are glued and assembled can be clamped. This allows less waste of glue, continuous gluing and clamping of subassemblies or final assemblies and more consistency in the gluing process. If a problem develops in the manufacturing, whatever number of subassemblies or final assemblies that are wet glued at a particular time can be pressed utilizing the required torque on the screws.

Another preferred benefit of this invention is the ability to use plastic film between the individual assemblies or final assemblies to prevent glue squeezed out during the clamping process from incorrectly gluing separate subassemblies or final assemblies together.

Another preferred benefit of this invention is the ability to reach into the frame and subassembly or final assembly area to clean off glue that is squeezed out during the clamping process thereby keeping the wood surfaces clean from excess, squeezed out, glue, and reducing the time required to clean the pallets up for subsequent painting. Also the finished pallet has a better visual appearance. Alternatively cull plates or similar sheets of glue release materials could be utilized between each wet glued unit.

The method of the subject invention provides for appropriate pressures to all the joints in the clamping device. This results in superior glued joints in the glued pallets. The unique configuration of the clamping device allows for all the glued joints in the block pallet to cure in a predictable manner. The resulting pallet has superior strength and durability in outdoor and indoor environments where it is subjected to high moisture content, sun, freeze thaw and other aggressive environmental conditions in combination with high loads and rough handling.

Another benefit of the subject invention is to allow a low cost repair clamping system for use in repairing small or large quanitites of pallets.

Testing has shown these glued wood pallets to be stronger, lighter and longer lasting than standard stringer and block pallets. Block pallets resist corner impact loads that cause weakening of standard pallets from twisting or being knocked out of square. Further the block pallets manufactured with the subject method withstand many more forklift tine load cycles. In addition the method of the subject invention results in pallets that can carry larger rack loads, have less creep in long term rack load situations. Further these pallets have superior vibrational damping resistance meaning that they are superior for carrying goods that have labels attached that can be marred or damaged during dynamic vibrational applied forces.

The use of the method of the subject invention to manufacture pallets produces a well glued, strong, and reliable pallet. The subject invention allows for proper closure of the glue line thickness to under 0.004″ to a target thickness of 0.001″ in all the glue lines, in all strata within a single or multiple pallet clamp situation or within a subassembly of a single or multiple pallet clamp situation at the same time. This allows block pallets to meet the requirements of water proof-mechanical glue type specifications. This device is economical to manufacture and specific to the manufacture of all glued pallets which could not be glued in conventional platen presses due to spacing and distribution of all the wood components. It can be portable to move around the manufacturing environment as needed.

In the method of the subject invention, pallet joints are cinched tightly by the stepped dowels and maintain tight seams. In doing so, the sealed, tight joints became microbe resistant. The dowels cinch the joints tightly together during fabrication. The dowels do not withdraw, which causes the joints to maintain that tight seal. The resulting joints do not provide gaps which can get moist and harbor microbes. This feature also makes it much easier to clean/wash and dry the pallets.

The method of the subject invention produces pallets of consistent thickness so that self stacking results in stable stacks that do not rock. This also provides for level stacking of empty pallets. There are no multiple stack requirements that cause even numbers of pallets with all the same thickness of strata to be used as would be required in a platen press. They also will stack to the same height for the same number of pallets. With this system pallets always lay flat without a twist in them.

An important part of the method involves manufacturing the pallets with the proper applied pressure glue system. This aspect of the invention controls clamping pressure between individual blocks within a pallet and within one stratum (e.g. blocks on corner) which can be very difficult in a normal platen pressure. To the equal pressure throughout all the joints in the pallet, a subassembly of the pallet is first made and then the whole pallet is assembled. This system allows pressure differences in any one stratum which can be very difficult to control in a conventional press setup. The use of stepped dowels and solid glued joints adds significantly to the rigidity and the strength of the pallet. The clamping system allows the right range for pressure over 125 psi and below 400 psi and preferably 300 psi to be achieved on each glue line. To get the proper pressure throughout all the joints in the pallet, subassemblies of the pallet are first made and then the whole pallet assembled. If dowels are utilized in the manufacture of the glued pallet, special care needs to be taken to insure that all the dowel caps are at least one sixteenth of an inch below the face of the pallet component to prevent pressure translation problems between strata within any one pressure clamp point (e.g. laminations in the strata hanging up on a proud dowel head).

It is to be recognized that the present invention has been described by way of example only and that modifications and/or alterations thereto which would be apparent to persons skilled in the art, based upon the disclosure herein, are also considered to fall within the spirit and scope of the invention.

1. A method of manufacturing a wooden pallet secured by glue and dowels comprising the steps of:
(1) preparing and arranging the pallet components;
(2) drilling dowel holes in the pallet components;
(3) applying glue to the dowels and the pallet components;
(4) assembling the pallet components to form assembled components;
(5) securing the assembled components together with dowels and glue; and
(6) clamping the assembled components for a period of time sufficient to allow the glue to cure and form an assembled wooden pallet.

2. The method of claim 1 wherein the step of clamping includes clamping the glued pallet components at a force of from about 125 psi to about 400 psi.

3. The method of claim 1 wherein the step of clamping the pallet components includes gluing and clamping the pallet components for about 4-12 hours.

4. The method of claim 1 wherein the step of changing the assembled components include clamping the assembled components for about 50-60 minutes.

5. A method of manufacturing a wooden pallet comprising the steps of:
(1) preparing a pallet ladder assembly by arranging deck boards, lead boards and stringer boards, drilling dowel holes, placing glue on the dowels and contact surfaces of the deck boards, lead boards and stringer boards, and securing together said deck boards, lead boards and stringer boards together to form the pallet ladder assembly;
(2) preparing a pallet bottom assembly by arranging bottom stringers, bottom lead boards and blocks, drilling dowel holes, placing glue on the dowels, driving dowels in dowel holes to secure the bottom stringers, the bottom lead boards and the blocks together to form the pallet bottom assembly;
(3) placing the ladder assembly adjacent the bottom assembly and securing together with glue and dowels to form a pallet assembly; and
(4) placing the pallet assembly into a clamp and clamping said pallet assembly with about 125 psi to about 400 psi for about 4 hours to about 12 hours.

6. The method of claim 5 wherein the step of clamping said pallet assembly is conducted with sufficient force to form tight joints with no gap.

7. The method of claim 6 wherein the tight joints are microbe resistant.

8. The method of claim 1 wherein the pallet assembly is clamped with a force of 300 psi.

9. The method of claim 8 wherein the pallet assembly is clamped for about 4 hours.
